(19) United States
(12) Patent Application Publication
(10) Pub. No.: US 2018/0161974 A1
(43) Pub. Date: Jun. 14, 2018

(54) Tool Holder Saddle

(71) Applicant: Jose A. Valenzuela, Albuquerque, NM (US)

(72) Inventor: Jose A. Valenzuela, Albuquerque, NM (US)

(21) Appl. No.: 15/838,351

(22) Filed: Dec. 11, 2017

Related U.S. Application Data
(60) Provisional application No. 62/431,990, filed on Dec. 9, 2016.

(51) Int. Cl. B25H 3/00; B60R 11/06; B65D 33/14

(52) U.S. Cl. CPC B25H 3/00; B65D 33/14; B60R 11/06

(57) ABSTRACT

A tool holder saddle has a flexible planar body, at least one support attachment, and a plurality of tool and accessory holders. At least one tool holder ring, at least one pocket, and at least one magnet are provided for holding tools and accessories, connected across the flexible planar body.

The current application claims a priority to the U.S. Provisional Patent application Ser. No. 62/431,990 filed on Dec. 9, 2016. The current application is filed on Dec. 11, 2017, whereas Dec. 9, 2017 and Dec. 10, 2017 were on a weekend.

### FIELD OF THE INVENTION

The present invention relates generally to a tool holder. More specifically, the present invention is a portable, flexible, multi-function holder for tools, accessories, and hardware for use while performing maintenance or other work on motor vehicles, airplanes, and the like.

### BACKGROUND OF THE INVENTION

Vehicle maintenance and repair can require a large variety of tools that usually are not within reach if the mechanic stays in one location. While performing maintenance, part replacement, or other work on a motor vehicle, aircraft, boat, or performing other similar tasks, the user may desire to have convenient access to tools, parts, accessories, and other items while performing their task. It is therefore an object of the present invention to provide users with a utility tool holder that can be affixed in a convenient location and provide easy access to a wide variety of tools without needing the user to move about in search of the appropriate tool, accessory, or part needed.

### BRIEF DESCRIPTION OF THE DRAWINGS

FIG. 1 is a depiction of one embodiment of the present invention.

FIG. 2 is a depiction of one embodiment of the present invention.

FIG. 3 is a depiction of one embodiment of the present invention.

FIG. 4 is a depiction of one embodiment of the present invention.

FIG. 5 is a depiction of one embodiment of the present invention.

FIG. 6 is a depiction of one embodiment of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

The present invention is a tool holder saddle meant to provide convenience to mechanics performing repairs or other operations on various vehicles or other related entities, such as, but not limited to, airplanes and other machines.

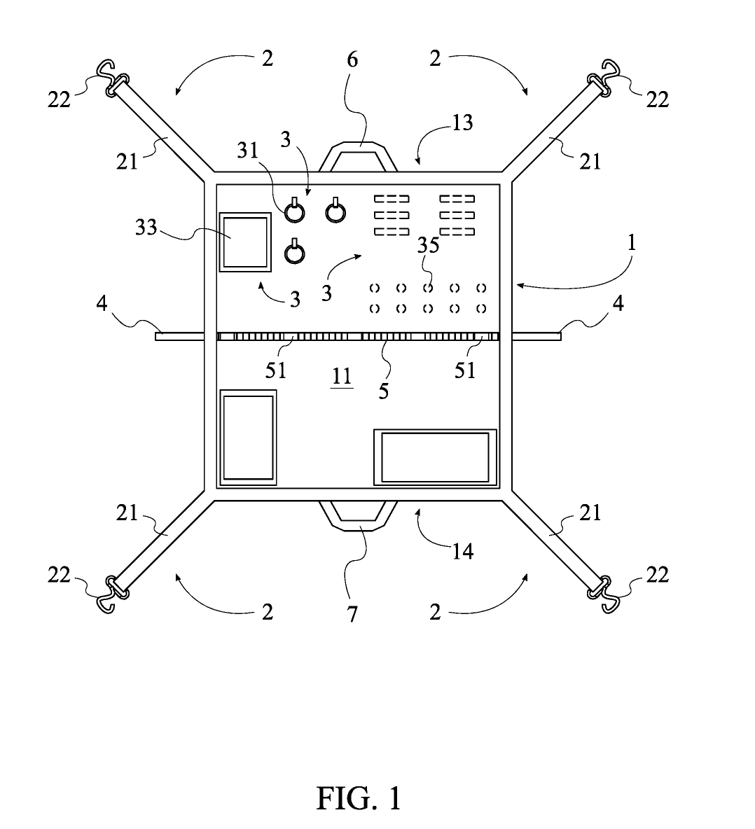

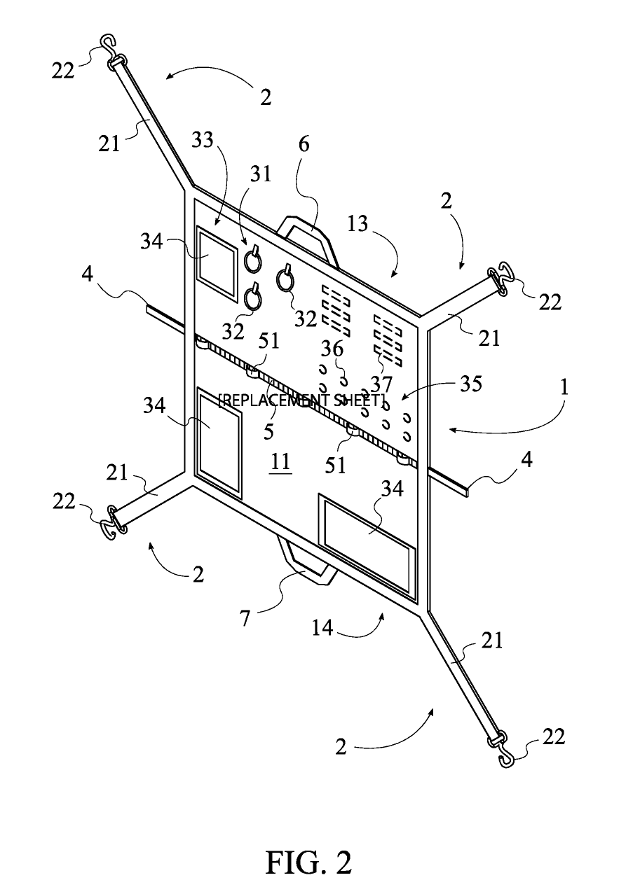

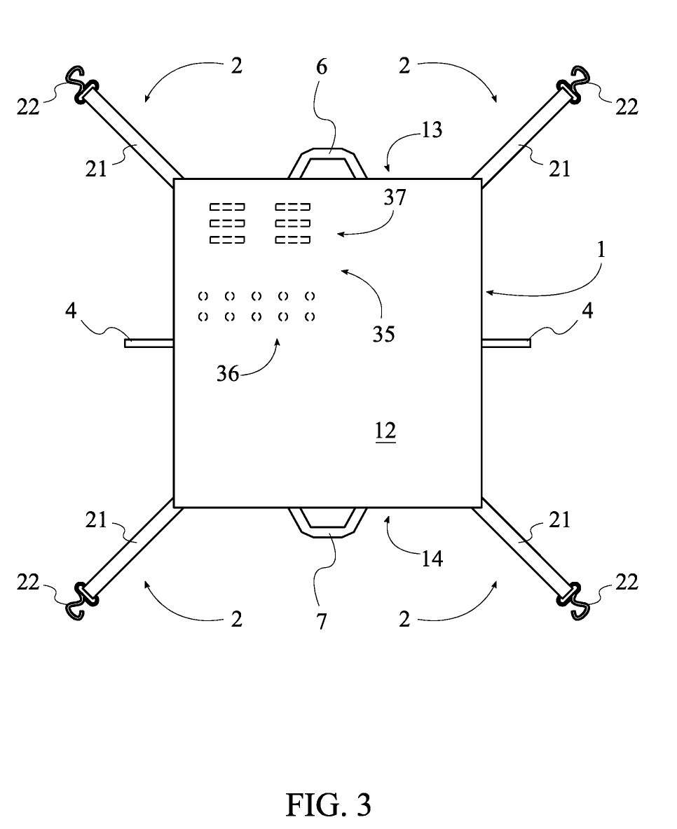

Referring to FIGS. 1-3, in general, the present invention comprises a flexible planar body 1, at least one support attachment 2, and a plurality of tool and accessory holders 3 comprising at least one tool holder ring 31, at least one pocket 33, and at least one magnet 35. In general, it should be understood that the present invention is intended to accommodate a wide variety of tools, accessories, hardware, and other objects that may be relevant to performing repair tasks upon a car, van, truck, or other automobile, or the like as necessary to the user. The spirit of the present invention is to provide a space for containing tools, hardware, accessories, and any other items that may be relevant to performing mechanical repair or other similar tasks upon automobiles or any other similar entities or structures.

The flexible planar body 1 is the primary supportive component of the present invention to which the plurality of tool and accessory holders 3 is connected. In some embodiments of the present invention, the flexible planar body 1 is constructed from a material such as, but not limited to: canvas, vinyl, any stitched or woven thread material, or any relevant and appropriate material.

The at least one support attachment 2 is meant to support the flexible planar body 1 upon whatever surface or structure is relevant and nearby to the operating space of the user performing mechanical maintenance. The plurality of tool and accessory holders 3 is connected across the flexible planar body 1.

The flexible planar body 1 comprises a tool holding surface 11, a rear surface 12, an upper end 13, and a lower end 14. The tool holding surface 11 and the rear surface 12 are layered opposite each other on the flexible planar body 1. The tool holding surface 11 and the rear surface 12 are positioned between the upper end 13 and the lower and. The at least one tool holder ring 31, the at least one pocket 33, and the at least one magnet 35 are connected to the tool holding surface 11. In some embodiments, the flexible planar body 1 is rectangular in shape. In other embodiments, the flexible planar body 1 may vary in shape.

In some embodiments, the at least one tool holder ring 31 is a plurality of tool holder rings 32. The number and arrangement of the plurality of tool holder rings 32 may vary in different embodiments. In any embodiments, the plurality of tool holder rings 32 is connected to the tool holding surface 11.

Furthermore, the at least one pocket 33 is a plurality of pockets 34 in the preferred embodiment of the present invention, wherein the plurality of pockets 34 is connected to the tool holding surface 11. Each of the plurality of pockets 34 may vary in size, shape, and position on the tool holding surface 11 as desired. Various members of the plurality of pockets 34 may be shaped and positioned differently according to various desired implementations, being designed accordingly to hold different tools, accessories, fastening hardware, personal cellular phones, or other items.

Preferably, the at least one magnet 35 comprises at least one round magnet 36 and at least one bar magnet 37, preferably with the at least one round magnet 36 and the at least one bar magnet 37 being positioned adjacent to each other on the tool holding surface 11. The at least one magnet 35, whether being a round magnet or a bar magnet, allows the user to temporarily affix tools, hardware, or other magnetically attracted objects to the tool holding surface 11 for temporary storage while the user is performing mechanical work. In some embodiments, some or each of the at least one magnet 35 is positioned within the flexible planar body 1 between the tool holding surface 11 and the rear surface 12. As such, the at least one magnet 35 may be stitched into the flexible planar body 1, or may be glued between the tool holding surface 11 and the rear surface 12, or may otherwise be affixed within the flexible planar body 1, concealed from view.

In some embodiments, the present invention may further comprise a central stitching 5. The central stitching 5 is oriented laterally on the flexible planar body 1, wherein the lateral direction is defined as perpendicular to the direction between the upper end 13 and the lower end 14. The central stitching 5 is positioned equidistant between the upper end 13 and the lower and. Furthermore, the central stitching 5 preferably comprises at least one loop 51. The at least one loop 51 further facilitates holding tools such as screwdrivers, wrenches, or other items. Each of the at least one loop 51 is configured in such a manner as to enable the user to place a tool vertically into the loop for convenient access.

The preferred embodiment of the present invention further comprises a first handle 6 and a second handle 7, with the first handle 6 being connected to the upper end 13, and the second handle 7 being connected to the lower end 14. The said configuration of the first handle 6 and the second handle 7 allows the user to fold the flexible planar body 1 of the present invention for convenience or transport and storage.

In the preferred embodiment of the present invention, the at least one support attachment 2 comprises a strap 21 and a hook 22, with the strap 21 being connected to the flexible planar body 1, and the hook 22 being connected to the strap 21 opposite the flexible planar body 1. Thus, the flexible planar body 1 may be supported in a desired position by the hook 22 being connected to any appropriate location. For example, the hook 22 of the at least one support attachment 2 may be affixed to any number of holes or other apertures in the underside of a hood of an automobile, should the present invention be utilized while performing maintenance in an automobile's engine bay. More specifically, in some embodiments, the at least one support attachment 2 comprises four support attachments, wherein each of the four support attachments is connected to one corner of the flexible planar body 1, wherein the flexible planar body 1 is considered to be rectangular in the current disclosure, though the shape of the flexible planar body 1 may vary in different embodiments. The present invention may also be draped over the side of an automobile for work on the wheel, tire or other lateral components of an automobile. In some embodiments, the strap 21 of the at least one support attachment 2 may not be included. Thus, in some embodiments, the hook 22 may be connected directly to the flexible planar body 1.

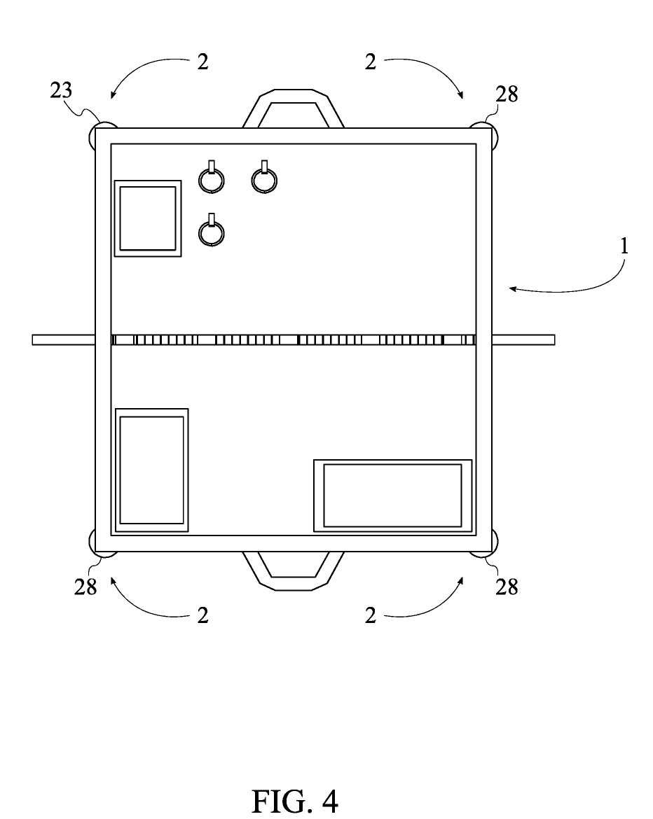

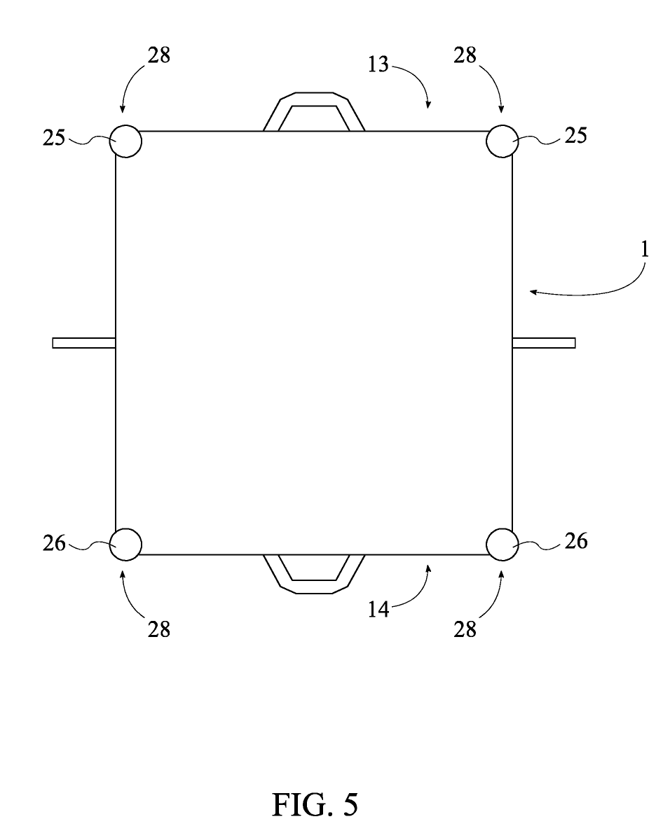

Referring to FIGS. 4-5, In some embodiments directed towards aviation, the at least one support attachment 2 may comprise a suction cup 23 connected to the flexible planar body 1. The suction cup 23 is intended for attachment to surfaces where the embodiment comprising the hook 22 may not be feasible due to the lack of apertures appropriate for connecting a hook 22 to.

In some embodiments, the at least one support attachment 2 comprises a plurality of suction cups 28 in order to properly support the flexible planar body 1 and thus the plurality of tool and accessory holders 3 in a convenient location for the user to access. In some embodiments, each of the plurality of suction cups 28 is connected to the flexible planar body 1.

In some embodiments, the plurality of suction cups 28 comprises a first pair of suction cups 25 and a second pair of suction cups 26, with the first pair of suction cups 25 being connected to the upper end 13 of the flexible planar body 1, and the second pair of suction cups 26 being connected to the lower and of the flexible body. It may be understood that the first pair of suction cups 25 and the second pair of suction cups 26 are connected as a group to the corners of the flexible planar body 1, in embodiments where the flexible planar body 1 is rectangular in shape.

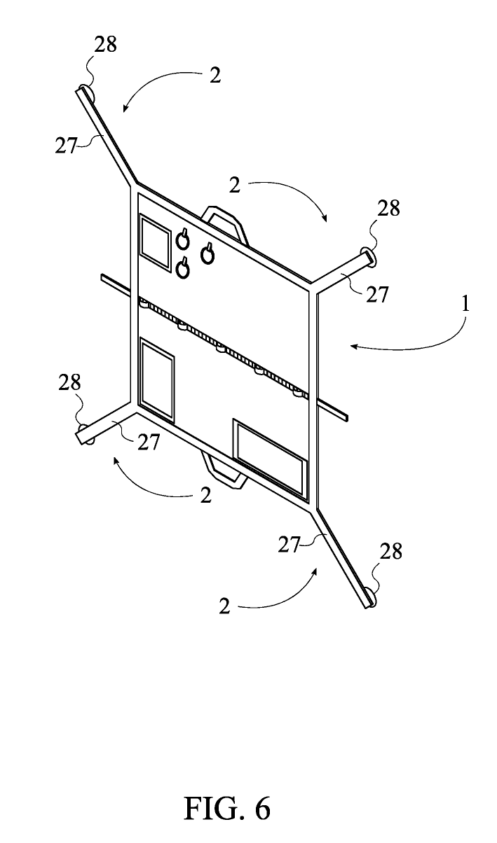

Referring to FIG. 6, in some embodiments, the at least one support attachment 2 comprises a plurality of straps 27 and a plurality of suction cups 28, with each of the plurality of straps 27 being connected to the flexible planar body 1, and each of the plurality of suction cups 28 being connection to one of the plurality of straps 27 opposite the flexible planar body 1.

Some embodiments of the present invention may further comprise at least one lateral support strap 4 connected to the flexible planar body 1 between the upper end 13 and the lower end 14. The at least one lateral support strap 4 may facilitate supporting the flexible planar body 1 on whatever surface, panel, or other structure may be relevant to the user in various applications. Each of the at least one lateral support strap 4 may comprise a loop positioned at a distal end of the lateral support strap 4 opposite the flexible planar body 1 in order to facilitate various attachment means. Each of the at least one lateral support strap 4 may further comprise a buckle or other relevant type of fastener or connection means to facilitate support of the flexible planar body 1 in a desired position by the user.

Although the invention has been explained in relation to its preferred embodiment, it is to be understood that many other possible modifications and variations can be made without departing from the spirit and scope of the tool holder saddle as hereinafter claimed.

What is claimed is:

1. A tool holder saddle comprises:
a flexible planar body;
at least one support attachment;
a plurality of tool and accessory holders comprising at least one tool holder ring, at least one pocket, and at least one magnet;
the plurality of tool and accessory holders being connected across the flexible planar body;
the flexible planar body comprises a tool holding surface, a rear surface, an upper end, and a lower end;
the tool holding surface and the rear surface being layered opposite each other on the flexible planar body;
the tool holding surface and the rear surface being positioned between the upper end and the lower end; and
the at least one tool holder ring, the at least one pocket, and the at least one magnet being connected to the tool holding surface.

2. The tool holder saddle as claimed in claim 1 comprises:
the flexible planar body being rectangular in shape.

3. The tool holder saddle as claimed in claim 1 comprises:
the at least one tool holder ring being a plurality of tool holder rings; and
the plurality of tool holder rings being connected to the tool holding surface.

4. The tool holder saddle as claimed in claim 1 comprises:
the at least one pocket being a plurality of pockets; and
the plurality of pockets being connected to the tool holding surface.

5. The tool holder saddle as claimed in claim 1 comprises:
at least one lateral support strap; and
the at least one lateral support strap being connected to the flexible planar body between the upper end and the lower end.

6. The tool holder saddle as claimed in claim 1 comprises:
a central stitching;
the central stitching being oriented laterally on the flexible planar body;
the central stitching being positioned equidistant between the upper end and the lower end; and
the central stitching comprises at least one loop.

7. The tool holder saddle as claimed in claim 1 comprises:
a first handle;
a second handle;
the first handle being connected to the upper end; and
the second handle being connected to the lower end.

8. The tool holder saddle as claimed in claim 1 comprises:
the at least one magnet comprises at least one round magnet and at least one bar magnet.

9. The tool holder saddle as claimed in claim 8 comprises:
the at least one round magnet and the at least one bar magnet being positioned adjacent to each other on the tool holding surface.

10. The tool holder saddle as claimed in claim 1 comprises:
each of the at least one magnet being positioned within the flexible planar body between the tool holding surface and the rear surface.

11. The tool holder saddle as claimed in claim 1 comprises:
the at least one support attachment comprises a strap and a hook;
the strap being connected to the flexible planar body; and
the hook being connected to the strap opposite the flexible planar body.

12. The tool holder saddle as claimed in claim 1 comprises:
the at least one support attachment comprises a suction cup; and
the suction cup being connected to the flexible planar body.

13. The tool holder saddle as claimed in claim 1 comprises:
the at least one support attachment comprises a plurality of suction cups; and
each of the plurality of suction cups being connected to the flexible planar body.

14. The tool holder saddle as claimed in claim 1 comprises:
the at least one support attachment comprises a plurality of suction cups;
the plurality of suction cups comprises a first pair of suction cups and a second pair of suction cups;
the first pair of suction cups being connected to the upper end of the flexible planar body; and
the second pair of suction cups being connected to the lower end of the flexible planar body.

15. The tool holder saddle as claimed in claim 1 comprises:
the at least one support attachment comprises a plurality of straps and a plurality of suction cups;
each of the plurality of straps being connected to the flexible planar body; and
each of the plurality of suction cups being connected to one of the plurality of straps opposite the flexible planar body.
